(19) United States
(12) Patent Application Publication
(10) Pub. No.: US 2013/0223636 A1
(43) Pub. Date: Aug. 29, 2013

(54) MEASUREMENT APPARATUS AND MEASUREMENT METHOD

(71) Applicants: Tadashi Amada, Ome-shi (JP); Toshifumi Yamamoto, Hino-shi (JP); Kimio Miseki, Ome-shi (JP)

(72) Inventors: Tadashi Amada, Ome-shi (JP); Toshifumi Yamamoto, Hino-shi (JP); Kimio Miseki, Ome-shi (JP)

(21) Appl. No.: 13/671,963

(22) Filed: Nov. 8, 2012

(30) Foreign Application Priority Data
Feb. 29, 2012 (JP) 2012-044370

(51) Int. Cl. H04R 29/00

(52) U.S. Cl. CPC H04R 29/001
USPC 381/58

(57) ABSTRACT

According to one embodiment, a measurement apparatus is configured to supply, to a output device, a second measurement signal to sweep the frequency, to receive a second received signal output from the output device when the second measurement signal is supplied to the output device, and to calculate an impulse response by convolving the second received signal and an inverted measurement signal having an inverted characteristic of the second measurement signal. The second measurement signal has a signal characteristic obtained by multiplying the first measurement signal by a characteristic of a characteristic of the amplitude spectrum.

### CROSS-REFERENCE TO RELATED APPLICATIONS

This application is based upon and claims the benefit of priority from Japanese Patent Application No. 2012-044370, filed Feb. 29, 2012, the entire contents of which are incorporated herein by reference.

### FIELD

Embodiments described herein relate generally to a measurement apparatus and a measurement method for measuring an impulse response of an object system comprising an output device and a receiving device.

### BACKGROUND

As a measurement signal for measuring an impulse response and a frequency characteristic, a sine sweep signal whose frequency sequentially varies with time is often used. A time-stretched pulse (TSP) signal is a typical sine sweep signal, and has a property of allowing measurement by use of a time signal having a maximum amplitude. As a result, the TSP signal is a measurement signal suitable for an object system (such as a loudspeaker) which has a substantially flat frequency characteristic. However, for an object system which has a non-flat frequency characteristic (such as when an earphone is measured directly by a microphone), a band having a low gain is easily masked by noise, and leads to a measurement result with low accuracy. Otherwise, when measurement is tried to measure a loud source by increasing output power of a measurement signal or by increasing an amplification ratio, a high-gain band exceeds a maximum value of a receiving level thereby causing distortion of a signal, and the signal cannot be measured in some cases.

For an object system which comprises an output device (encapsulated earphone) and a receiving device (microphone) and has a receiving signal whose frequency characteristic is non-flat, accuracy of a measurement result was sometimes low if an impulse response of an object system is measured by using a TSP signal having a time signal with the maximum amplitude throughout the entire frequency.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an exterior of a measurement apparatus (playback apparatus) according to an embodiment.

FIG. 2 is an exemplary block diagram showing a system configuration of the measurement apparatus (playback apparatus) according to the embodiment.

FIG. 3 is an exemplary block diagram showing an example of a configuration for measuring an impulse response and a frequency characteristic of a media player according to the embodiment.

FIG. 4 is an exemplary diagram showing a frequency characteristic of sound output from an earphone and obtained by a microphone.

FIG. 5 is an exemplary schematic diagram showing a waveform obtained by subjecting a common TSP signal to inverted Fourier conversion.

FIG. 6 is an exemplary diagram showing an amplitude spectrum of sound output from the earphone when the TSP signal shown in FIG. 5 is input to the earphone.

FIG. 7 is an exemplary diagram showing a frequency amplitude spectrum obtained by performing Fourier conversion on a waveform shown in FIG. 6.

FIG. 8 is an exemplary diagram showing a spectrum of a received signal when an output sound from the earphone is measured with the microphone positioned close.

FIG. 9 is an exemplary diagram showing a frequency amplitude spectrum of an impulse response obtained from the spectrum shown in FIG. 8.

FIG. 10 is an exemplary diagram showing a spectrum of a received signal when a volume of a reproduced signal is increased or an amplification ratio of a microphone amplifier is increased.

FIG. 11 is an exemplary diagram showing a spectrum of a measurement signal obtained by weighting a TSP signal.

FIG. 12 is an exemplary graph showing a weight coefficient W(k) used when creating the TSP signal shown in FIG. 11, and 1/W(k) used when creating an inverted TSP signal thereof.

FIG. 13 is an exemplary diagram showing a spectrum of a received signal when sound output from the earphone is measured with a microphone positioned close.

FIG. 14 is an exemplary diagram showing a spectrum of a received signal when sound output from the earphone is measured with a reproduction sound volume increased and with a microphone positioned close.

FIG. 15 is an exemplary diagram showing a frequency amplitude spectrum of an impulse response obtained from the spectrum shown in FIG. 14.

FIG. 16 is an exemplary block diagram showing an example of a configuration of a correction function of a media player.

FIG. 17 is an exemplary diagram showing an example of a frequency characteristic indicated by target characteristic data.

FIG. 18 is an exemplary diagram showing a frequency characteristic indicated by a designed correction filter.

FIG. 19 is an exemplary diagram showing a frequency characteristic of sound output from the earphone.

FIG. 20 is an exemplary flowchart showing a procedure of measuring a frequency characteristic of sound output from the earphone and correcting the sound output from the earphone, based on the measured frequency characteristic.

FIG. 21 is an exemplary diagram showing a modification of the TSP signal shown in FIG. 10.

FIG. 22 is an exemplary graph showing a weight coefficient W(k) used when creating a TSP signal shown in FIG. 21, and 1/W(k) used when creating an inverted TSP signal thereof.

### DETAILED DESCRIPTION

Various embodiments will be described hereinafter with reference to the accompanying drawings.

In general, according to one embodiment, a measurement apparatus is configured to measure an impulse response by using an object system comprising an output device configured to output a first output signal corresponding to a supplied first measurement signal for sweeping a frequency, and a receiving device configured to output a first received signal by receiving the first output signal. The first received signal has a known characteristic of an amplitude spectrum. The apparatus comprises an output module, a receiving module, and an impulse response calculator. The output module is configured to output, to the output device, a second measurement signal obtained by multiplying the first measurement signal by a weight comprising an inverted characteristic of the amplitude spectrum. The receiving module is configured to receive a second received signal output from the receiving device when the second measurement signal is supplied from the output module to the output device. The impulse response calculator is configured to calculate the impulse response by convolving the second received signal and an inverted measurement signal having an inverted characteristic of the second measurement signal.

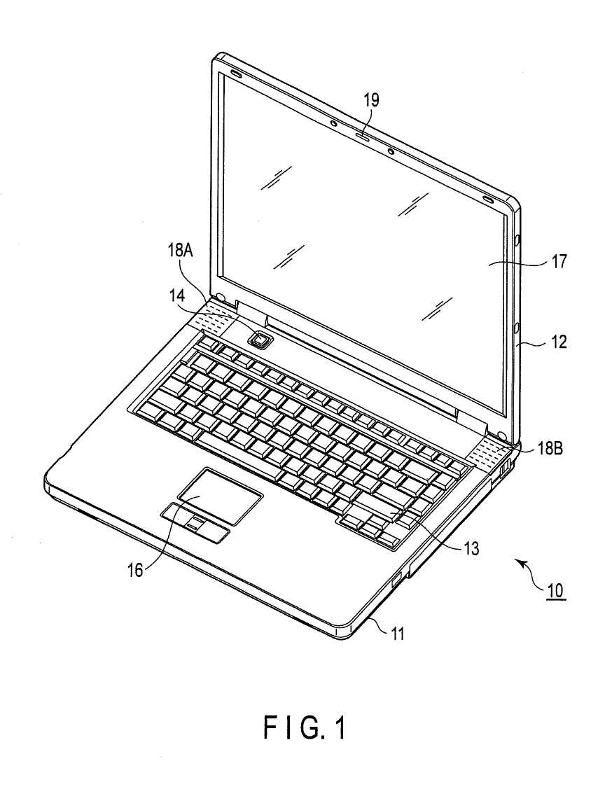

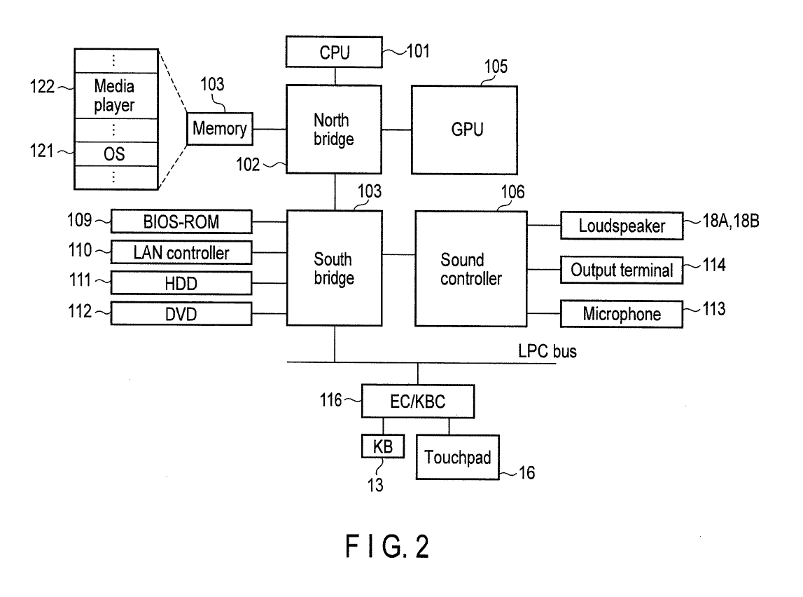

At first, a configuration of a measurement apparatus (playback apparatus) will be described with reference to FIGS. 1 and 2. The measurement apparatus (playback apparatus) is configured, for example, as a notebook-type mobile personal computer 10.

FIG. 1 is a perspective view showing a state where a display unit of the computer 10 is opened. The present computer 10 comprises a computer body 11 and a display unit 12. A display panel 17 is incorporated into the display unit 12 comprising a liquid crystal panel. A microphone is provided in the display unit 12. A microphone hole 19 is formed in the display unit 12 in order that the microphone can efficiently collect sounds.

The display unit 12 is attached to the computer body 11 in a manner that the display unit 12 can be freely pivoted between an open position to expose an upper surface of the computer body 11 and a closed position to cover the upper surface. The computer body 11 comprises a thin box-type housing. A keyboard 13, a power button 14 to power on/off the computer 10, a touchpad 16, and loudspeakers 18A and 18B are provided on the upper surface of the housing.

Next, the system configuration of the present computer 10 will be described with reference to FIG. 2.

As shown in FIG. 2, the computer 10 comprises a Central Processing Unit (CPU) 101, a north bridge 102, a main memory 103, a south bridge 104, a graphics processing unit (GPU) 105, a video memory (VRAM) 105A, a sound controller 106, a BIOS-ROM 109, a LAN controller 110, a hard-disk drive (HDD) 111, a DVD drive 112, and an embedded controller/keyboard controller IC (EC/KBC) 116.

The CPU 101 is a processor to control operation of the computer 10, and executes various application programs, such as an operating system (OS) 121 and a media player 122, which are loaded from the hard-disk drive (HDD) 111 into the main memory 103. The media player 122 is application software for reproducing files of motion pictures (videos) and audio. Further, the CPU 101 also executes a Basic Input/Output System (BIOS) stored in the BIOS-ROM 109. The BIOS is a program for hardware control.

The north bridge 102 is a bridge device which connects a local bus of the CPU 101 and the south bridge 104 to each other. The north bridge 102 also includes a memory controller which performs access control on the main memory 103. Also, the north bridge 102 has a function to perform communication with the GPU 105 through a serial bus according to the PCI EXPRESS standard.

The GPU 105 is a device which controls the LCD 15A used as a display of the computer 10. The GPU 105 uses the VRAM 105A as a work memory. A video signal generated by the GPU 105 is fed to the liquid crystal panel.

The south bridge 104 controls devices on a Low Pin Count (LPC) bus and a Peripheral Component Interconnect (PCI) bus. Further, the south bridge 104 includes an Integrated Drive Electronics (IDE) controller for controlling the hard-disk drive (HDD) 111 and DVD drive 112. The south bridge 104 further has a function to communicate with the sound controller 106. The sound controller 106 is a sound source device, and comprises circuits such as a digital-to-analog converter which converts a digital signal into an electrical signal, and an amplifier which amplifies the electrical signal, in order to output audio data as a reproducing target to loudspeakers 18A and 18B. The sound controller 106 comprises circuits such as a microphone amplifier which amplifies the electrical signal input from a microphone 113, and an analog-to-digital converter for converting the amplified electrical signal into a digital signal.

The embedded controller/keyboard controller (EC/KBC) 116 is a one-chip microcomputer which integrates an embedded controller for performing power management, and a keyboard controller for controlling the keyboard (KB) 13 and a pointing device 16. The embedded controller/keyboard controller (EC/KBC) 116 has a function to power on/off the computer 10 in accordance with operation of the power button 14 by a user.

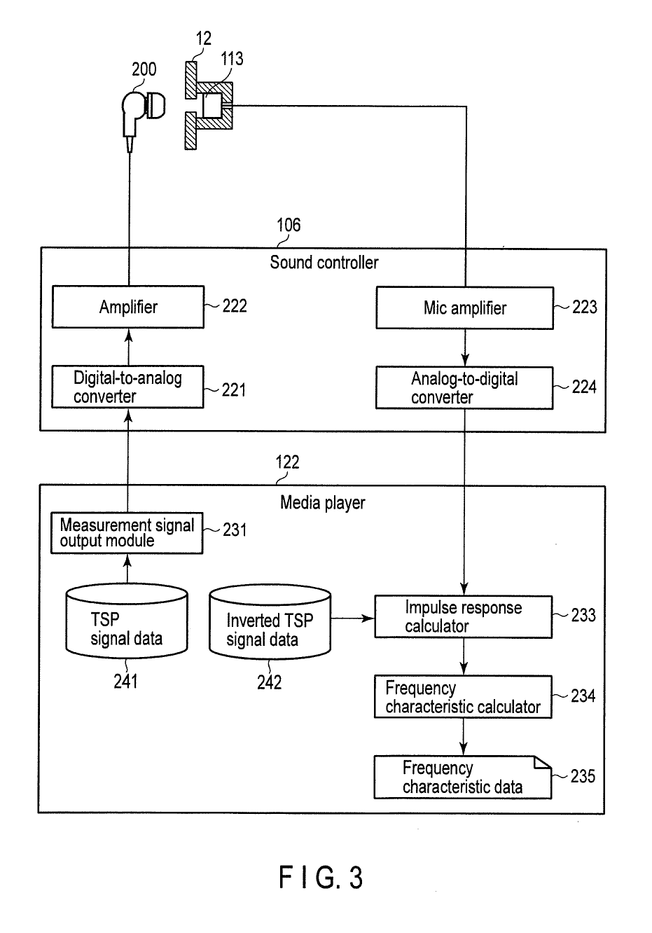

Next, functions of the media player 122 will be described. The media player 122 has a function to measure an impulse response and a frequency characteristic of sound output from a closed-type earphone. A configuration for measuring a frequency characteristic will be described with reference to FIG. 3.

The media player 122 comprises a measurement-signal output module 231, an impulse-response calculator 233, and a frequency-characteristic calculator 234.

The measurement-signal output module 231 outputs, for example, TSP signal data stored in the HDD 111 to a digital-to-analog converter 221.

The sound controller 106 comprises the digital-to-analog converter 221, an amplifier 222, a microphone amplifier 223, and an analog-to-digital converter 224.

The measurement-signal output module 231 outputs TSP signal data 241 as digital data to the digital-to-analog converter 221. The digital-to-analog converter 221 converts the TSP signal data 241 into an analog measurement signal. The converted analog measurement signal is amplified by the amplifier 222, and the amplified analog measurement signal is supplied to a closed-type earphone 200. The earphone 200 outputs a signal corresponding to the supplied measurement signal. Sound output from the earphone 200 is received by the microphone 113. The microphone 113 converts the received sound into an electrically measured signal (received signal), and supplies the measured signal to the microphone amplifier 223. The microphone amplifier 223 amplifies the measured signal and supplies the measured signal to the analog-to-digital converter 224. The analog-to-digital converter 224 converts the measured signal into digital data, and outputs the converted measured signal to the impulse-response calculator 233. The impulse-response calculator 233 calculates the impulse response by convolving inverted TSP signal data 241 into the measured signal (by performing convolution calculation on the measured signal and the inverted TSP signal data 241). Convolution calculation is known to reduce sometimes a calculation amount of the impulse response by calculating the calculation amount as a product of the measured signal and Fourier conversion of the inverted TSP signal data 241. The inverted TSP signal data 241 is stored in, for example, the HDD 111.

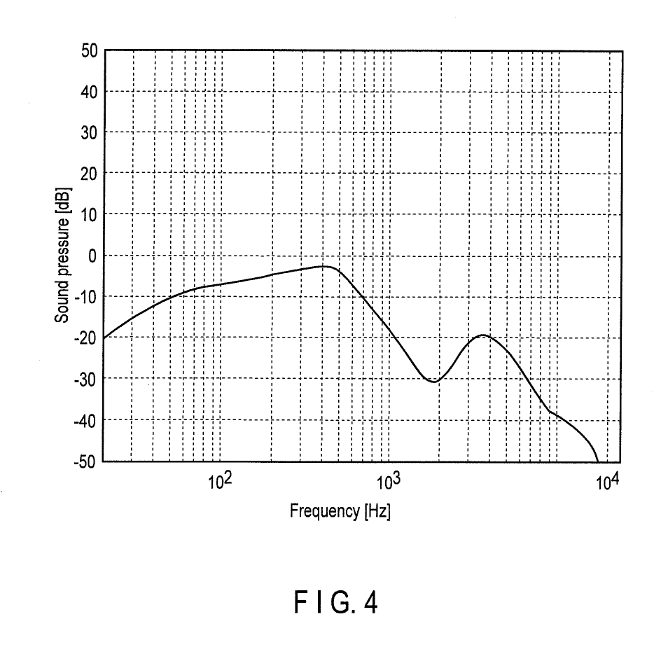

The impulse-response calculator 233 supplies the calculated impulse response to a frequency-measurement calculator 234. The frequency-measurement calculator 234 calculates a frequency amplitude spectrum by performing Fourier conversion on the impulse response. FIG. 4 shows a frequency characteristic of sound obtained by the microphone 113 output from the earphone 200.

The amplifier 222 on a reproducing side is adjusted so as to attain a sound volume adequate for the earphone 200. The microphone amplifier 223 on a receiving side is required to adjust a dynamic range of a measured signal to be as wide as possible. The TSP signal has a frequency which sequentially varies with time to sweep the frequency, and is often used to measure characteristics of a sound device. There are a variety of modified TSP signals. For example, a standard TSP signal and a log−TSP signal having a logarithmic frequency sweep which sweeps more lately as the frequency becomes lower are defined as follows.

$$\begin{matrix}{H}_{TSP} ( k ) = \{ \begin{matrix}exp ( - j 4 m π {k}^{2} / {N}^{2} ) & ( 0 \leq k \leq N / 2 ) \\ {H}_{TSP}^{*} ( N - k ) & ( N / 2 < k < N )\end{matrix} & ( 1 ) \\ {H}_{LOG - TSP} ( k ) = \{ \begin{matrix}1 & ( k = 0 ) \\ \frac{exp ( - j ak log ( k ) )}{\sqrt{k}} & ( 1 \leq k \leq N / 2 ) \\ {H}_{Log - TSP}^{*} ( N - k ) & ( N / 2 < k < N )\end{matrix} \\ where a = 2 m π / ( N / 2 ) log ( N / 2 ) \\ ( m \text{:} integer ) & ( 2 )\end{matrix}$$

In the above expression, N represents a signal length of TSP and log−TSP, and m represents a parameter which determines a pulse width. Also, k is a parameter which determines a frequency, and superscript * represents a complex conjugate.

Further, the inverted TSP signal is defined as a complex conjugate of the TSP signal in a frequency range. For measurement, H_{TSP}(k) is subjected to inverted Fourier conversion and thereby converted into a signal which takes time as a parameter. The converted signal is reproduced and used.

FIG. 5 is a schematic diagram showing a. waveform obtained by subjecting H_{TSP}(k) to the inverted Fourier conversion. Thus, the TSP signal is formed of a sine wave whose amplitude is constant and frequency sequentially varies. FIG. 5 shows an example in which a maximum value is 100% to simplify descriptions. This measurement signal is input to a measurement target (earphone), and a received signal is obtained by observing an output thereof.

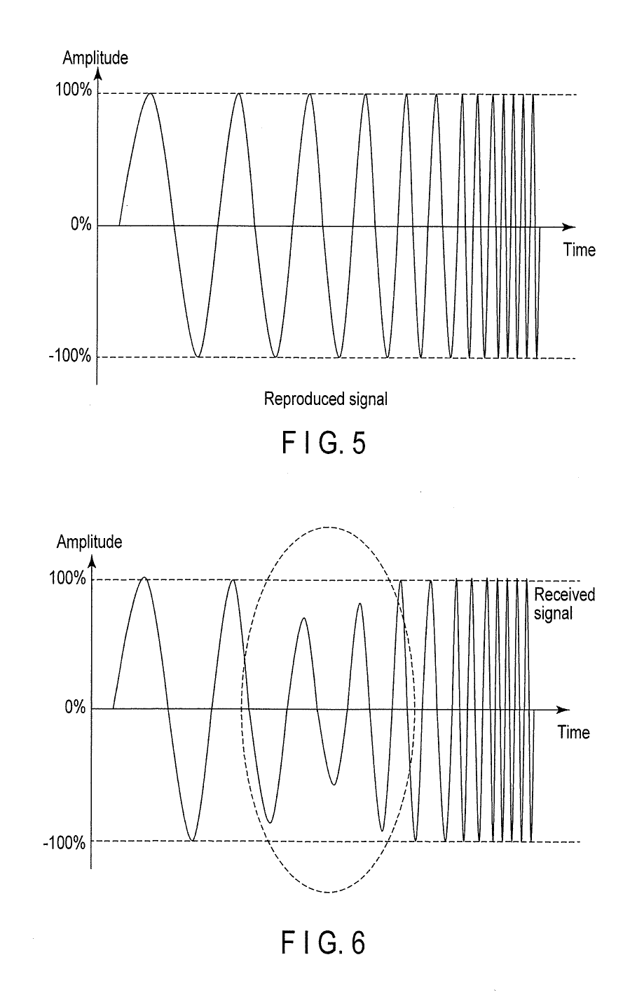

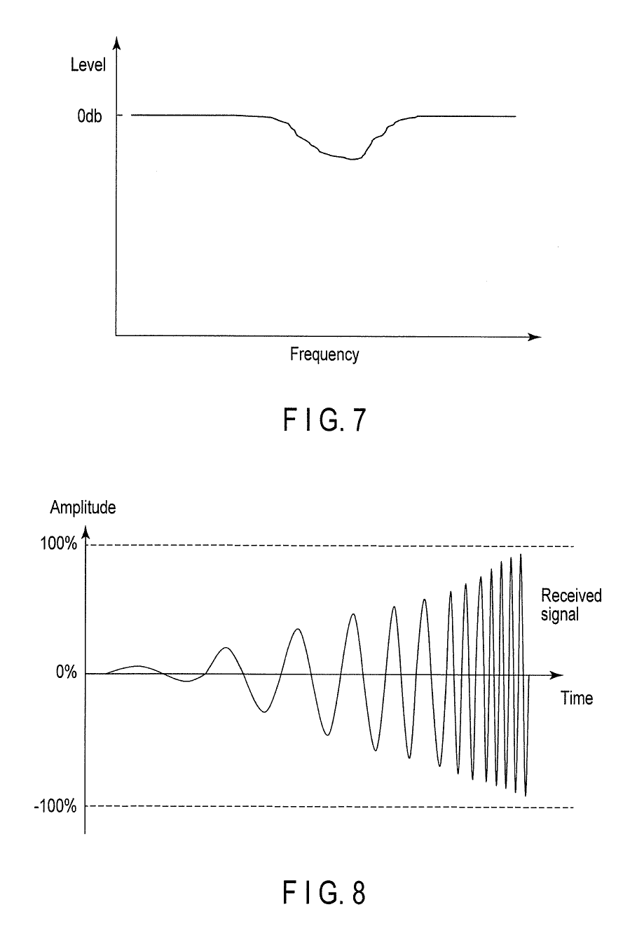

FIG. 6 shows an example of the received signal. In the example shown in FIG. 6, an amplitude of a waveform near the center thereof decreases although an amplitude of 100% equal to a reproduced signal is obtained in the other areas. An impulse response can be obtained by convolving the inverted TSP signal into this received signal. By further performing Fourier conversion, a frequency spectrum as shown in FIG. 7 can be obtained.

FIG. 7 shows, as 0 dB, a frequency observed at the same level as an input. The received signal shown in FIG. 7, the amplitude of the spectrum of the frequency corresponding to a concave near the center of the received signal shown in FIG. 6.

For example, when a frequency characteristic of an earphone is to be measured, the measurement signal shown in FIG. 5 is reproduced by an audio player, and audio output from the earphone is obtained by a microphone. By convolving an inverted TSP signal into the measurement signal, the impulse response and frequency characteristic can be obtained.

Meanwhile, when an output sound from the earphone 200 is measured with the microphone 113 put close to the closed-type earphone 200, the observed sound becomes smaller as the frequency becomes lower. This is caused by a physical phenomenon that a lower sound is difficult to hear in measurement in an open state since the closed-type earphone 200 is designed considering resonance in an encapsulated state with the earphone 200 worn in an ear. Here, this kind of system is called a high-pass system.

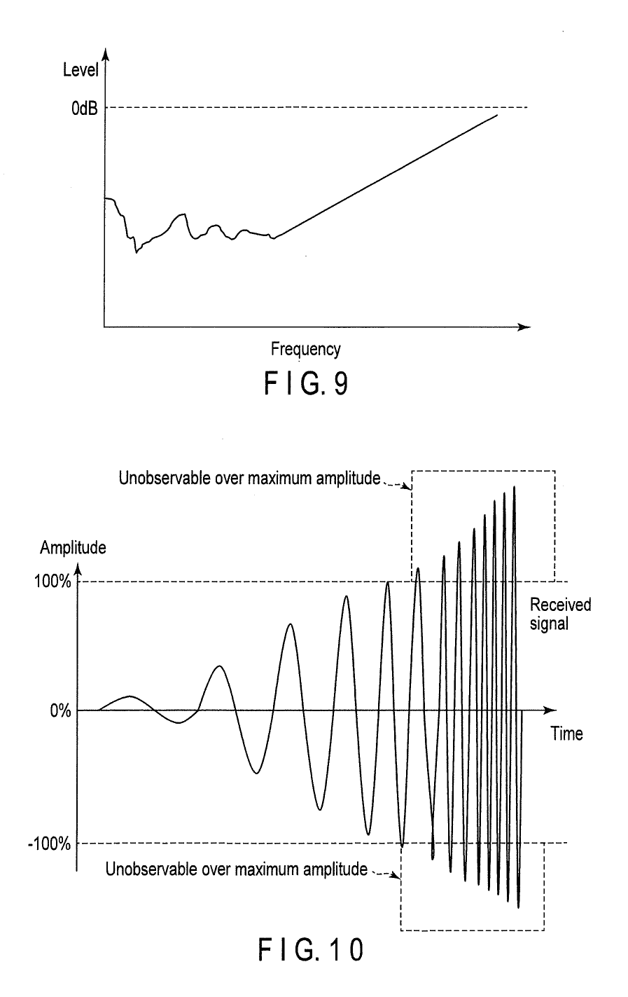

A received signal obtained by receiving sound output from the high-pass system by the microphone 113 has a waveform shown in FIG. 8. As shown in FIG. 8, an amplitude at a low frequency is observed to be extremely small, compared with an amplitude in a high-frequency band. An impulse response is generated by convolving an inverted TSP signal into a frequency amplitude spectrum shown in FIG. 8. FIG. 9 shows a frequency amplitude spectrum of a generated impulse response. In a high-frequency band, a sound volume close to 0 dB equal to the level of the measurement signal can be obtained. As the frequency decreases, the amplitude decreases. When the amplitude decreases too much, a correct measured value cannot be obtained because of masking by noise. If the sound volume of the reproduced signal is increased by the amplifier 222 or the amplification ratio of the microphone amplifier 223 is increased to increase the level of the received signal, the received signal has a waveform as shown in FIG. 10. In a high-frequency band, there is a problem that an upper limit value of the amplitude is exceeded to thereby cause deformation. To solve the problems as described above, the present embodiment uses, as a measurement signal, a signal weighted with a frequency component of the TSP signal according to the present embodiment. Specifically, a measurement signal M(k) obtained by multiplying a frequency weight W(k) by H(k) according to expression (1) or (2) as expressed in expression (3).

$$M ( k ) = \{ \begin{matrix}H ( k ) \times W ( k ) & ( 0 \leq k \leq N / 2 ) \\ {M}^{*} ( N - k ) & ( N / 2 < k < N )\end{matrix} \qquad ( 3 )$$

The inverted TSP signal (Mᵢₙᵥ(k)) is defined by the following expression (4).

$${M}_{inv} ( k ) = \{ \begin{matrix}{H}^{*} ( k ) \times {W}^{*} ( k ) & ( 0 \leq k \leq N / 2 ) \\ {M}_{inv}^{*} ( N - k ) & ( N / 2 < k < N )\end{matrix} \qquad ( 4 )$$

The weight is also adaptive to a TSP signal other than the TSP signal described above and the log−TSP signal.

Practically, the weight is determined experimentally. Patterns of the amplitude of the received signal are observed about several measurement targets, and a weight of W(k)<1 is set for a frequency component having a great amplitude. Ideally, the received signal can be set to be a signal having substantially no deviated amplitude by setting, as W(k), the inverted characteristic of an average frequency amplitude spectrum of an object system.

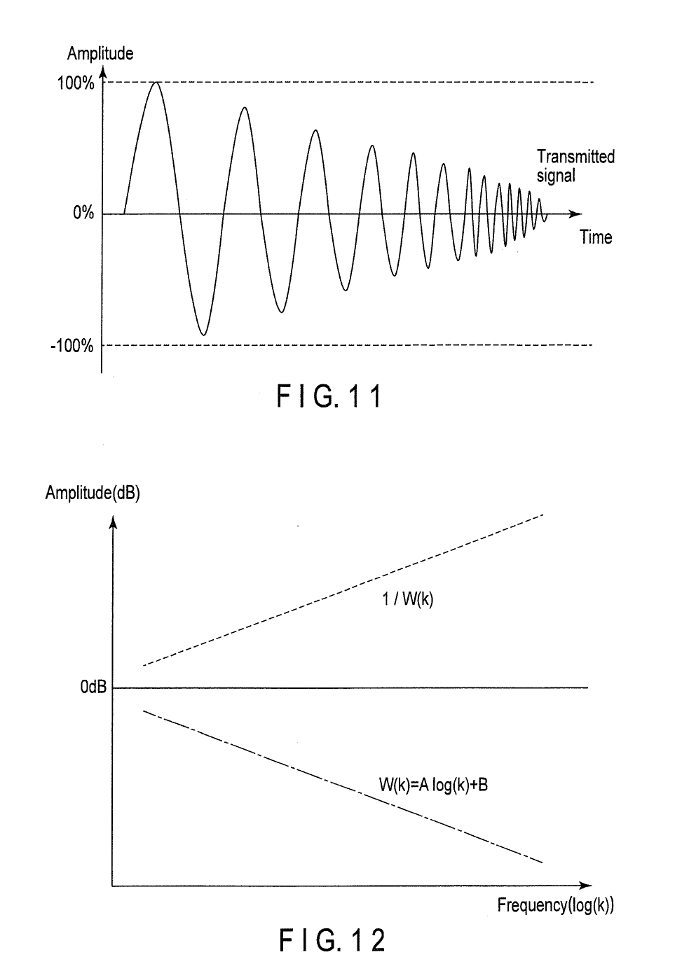

The measurement signal shown in FIG. 11 is a TSP signal with a weighted amplitude, which is prepared by designing W(k) for the high-pass system. An amplitude of a measurement signal is limited by using a smaller W(k) as the gain of an object system of the frequency band becomes higher in a higher band.

FIG. 12 is a graph showing a weight coefficient W(k) used when creating the TSP signal shown in FIG. 11, and 1/W(k) used when creating the inverted TSP signal. When the object system is known to increase toward a high-frequency band, a weight which decreases in the high-frequency band and has an inverted characteristic is applied to the TSP signal, like the weight W(k) shown in FIG. 12. From a low-frequency band to a high-frequency band, measurement can be performed with high accuracy. The weight 1/W(k) applied to the inverted TSP is designed to be symmetrical to the weight W(k) about 0 dB.

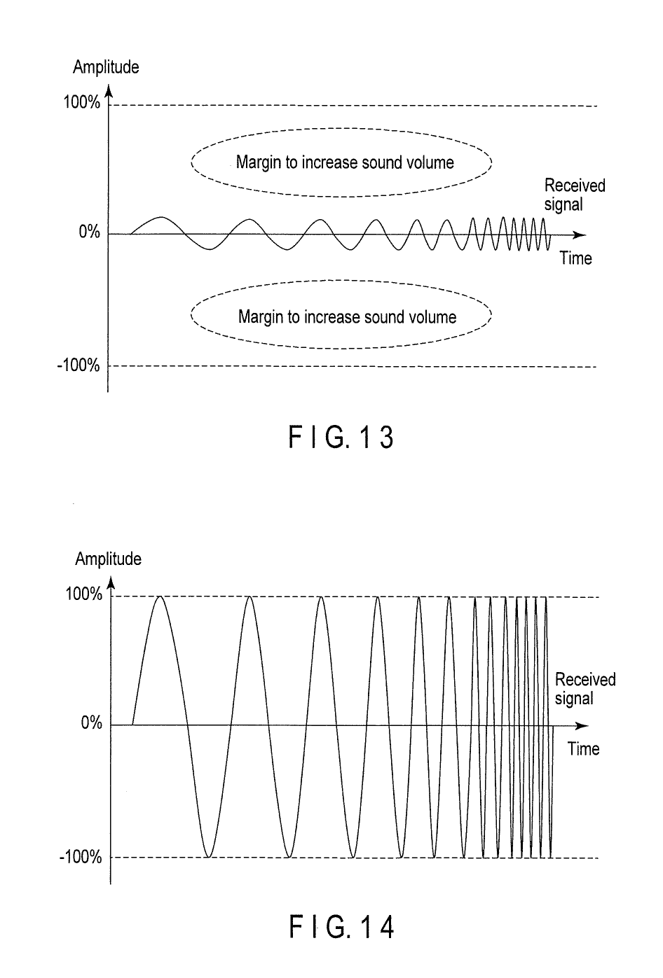

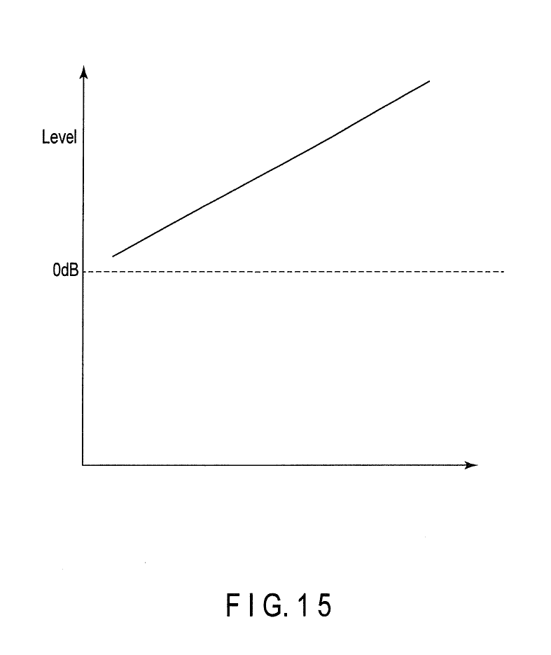

The TSP signal is output from the high-pass system, and a received signal whose amplitude is not deviated as shown in FIG. 13 is obtained. However, a reproduced volume level and a received volume level are the same as those in a conventional method. Concerning a low-frequency band, the weight W(k) of the measurement signal is close to 1, and therefore, a waveform having a small amplitude as in the conventional method is observed. Concerning a high-frequency band, the measurement signal is limited by W(k), and a waveform having a small amplitude is therefore observed directly. In this state, the entire band is masked by noise. However, an observed waveform as shown in FIG. 14 is obtained by increasing the reproduced sound volume or the received signal volume. Regardless of whether in the low- or high-frequency band, measurement can be performed with a high gain. When a frequency amplitude spectrum is obtained after performing an inverted TSP processing, the frequency amplitude spectrum has a waveform as shown in FIG. 15. The volume of the signal in the low-frequency band is increased. Therefore, even when a gain drops in the object system, the sound volume is increased to compensate for the drop, and the signal takes a value close to 0 dB. Since the signal in the high-frequency band is initially set to have a small amplitude, the maximum amplitude of the received signal is not exceeded even when the gain of the object system is high in the high-frequency band. Further, since the received signal is observed to be greater than the reproduced signal, a higher frequency amplitude characteristic than 0 dB is obtained. Thus, the dynamic range of the received signal is effectively used by processing the amplitude value of the TSP signal in compliance with properties of the object system in advance. A signal in a band in which the received signal level is so low and masked by noise by the conventional method can be measured with a sufficient sound volume.

If the reproduction volume can be increased by the amplifier 222, the received signal can be adjusted so as not to overflow by reducing the level in the receiving side, without using the present method. Then, noise which is superposed by the object system can be reduced, and the signal-to-noise ratio can be improved even when the received signal is weak in a low-frequency band. In actuality, there are problems such as circuit noise added after receiving a signal and quantization distortion, and sufficient performance cannot be obtained. It is therefore effective to maintain a sufficient amplitude in a step of the received signal by using the present method. Further, in quite a few cases, levels of microphones cannot be changed freely in different apparatuses from a measurement apparatus, such as a personal computer or a smartphone. Even in such cases, the level of a reproduced signal needs to be adjusted, and the present method is effective.

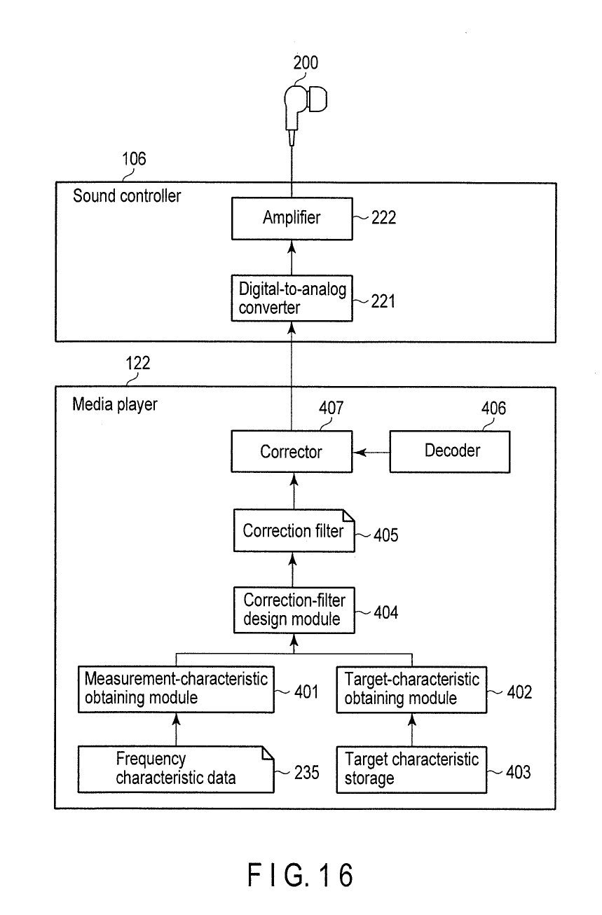

Next, a reproduction function of the media player using a frequency characteristic of sound output from the earphone 200 will be described. The reproduction function of the media player includes a correction function of causing the sound output from the earphone 200 to have a target frequency characteristic, based on the measured frequency characteristic of the earphone 200. Next, a configuration of the correction function of the media player will be described with reference to FIG. 16.

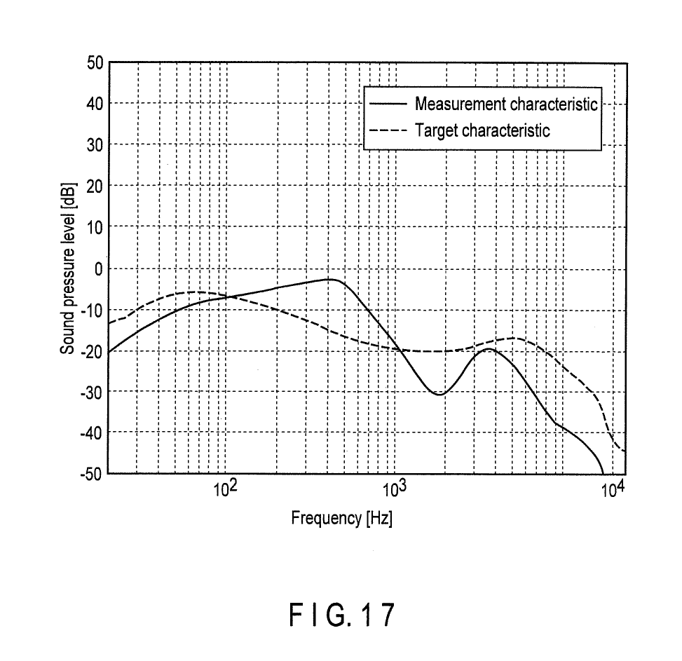

As shown in FIG. 16, the media player comprises a measurement-characteristic obtaining module 401, a target-characteristic obtaining module 402, a correction-filter design module 404, a decoder 406, and a corrector 407. The measurement-characteristic obtaining module 401 obtains the frequency characteristic data 235 generated by a frequency-characteristic calculator 234. The target-characteristic obtaining module 402 obtains, from a target characteristic storage 403, target characteristic data indicating a target frequency characteristic of sound which is output from the earphone 200 and reaches an ear drum. The target characteristic storage 403 stores, for example, a plurality of target characteristic data. One of the plurality of target characteristic data indicates, for example, an ideal frequency characteristic. Another one of the plurality of target characteristic data corresponds to a plurality of music genres. FIG. 17 shows an example of frequency characteristics indicated by the target characteristic data. The target-characteristic obtaining module 402 obtains one of target characteristic data selected by a user among the plurality of target characteristic data stored in the target characteristic storage 403.

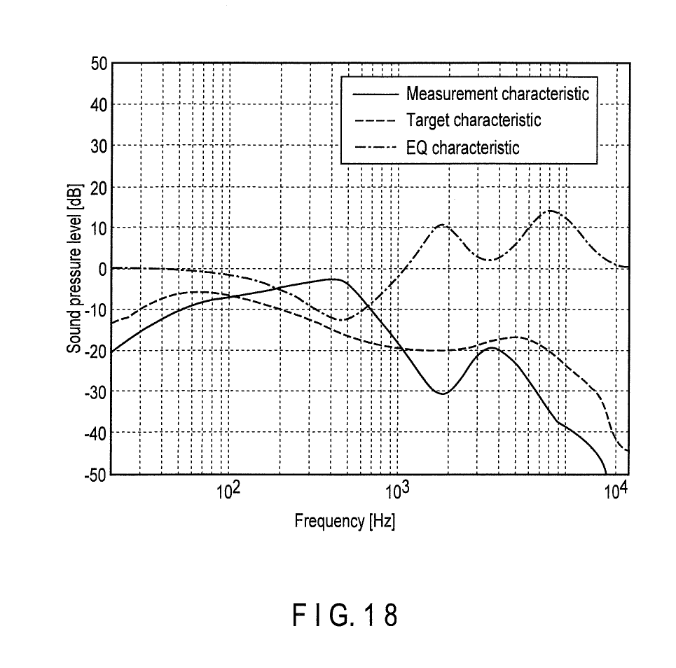

The correction-filter design module 404 designs a correction filter (correction data) 405 to approximate the sound which is output from the earphone 200 and reaches an eardrum, based on target characteristic data and frequency characteristic data. FIG. 18 shows frequency characteristics indicated by the correction filter 405. The correction filter 405 has, for example, parameters used by a common parametric equalizer. The parameters used by the parametric equalizer are a center frequency, a band width to adjust, and a sound volume.

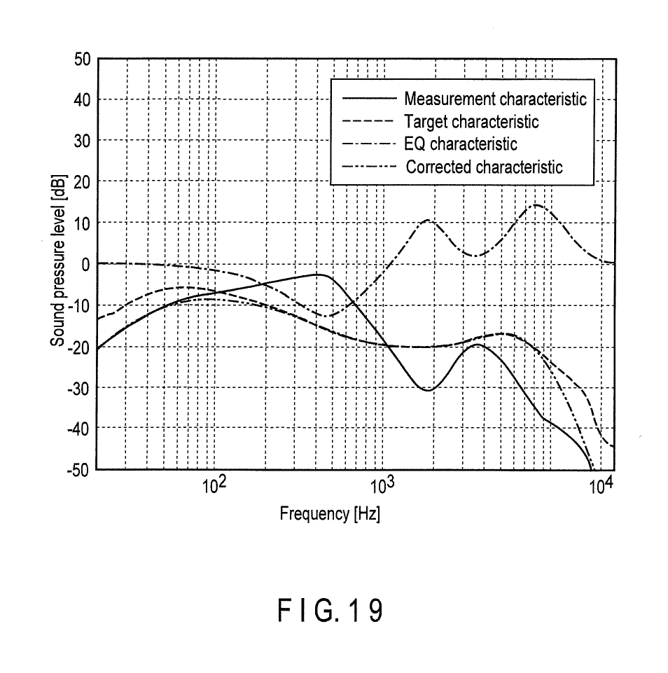

The decoder 406 generates audio data by decoding data encoded by a compression format such as MP3. The corrector 407 corrects audio data, based on a correction filter prepared by the correction-filter design module 404. Corrected audio data is input to a digital-to-analog converter. The digital-to-analog converter converts audio data into an electrical signal and outputs the converted electrical signal to the amplifier. The amplifier amplifies the electrical signal and outputs the amplified electrical signal to the earphone 200. FIG. 19 shows frequency characteristics (including a corrected characteristic) of sound output from the earphone 200. As shown in FIG. 19, the corrected characteristic is substantially equal to a target characteristic.

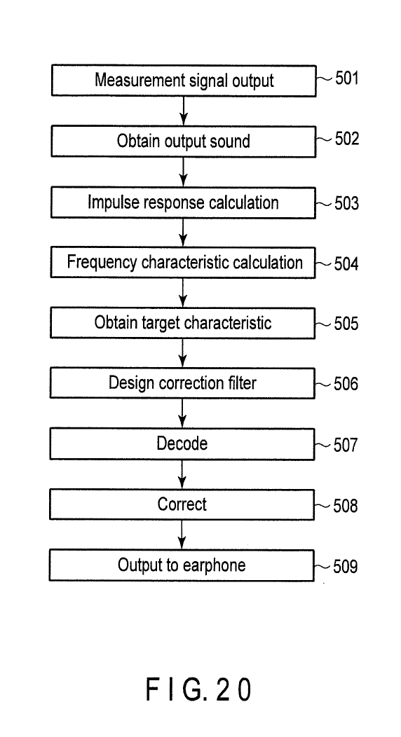

Next, a procedure of measuring a frequency characteristic of sound output from the earphone 200 and correcting the sound output from the earphone 200 on the basis of the measured frequency characteristic will be described with reference to the flowchart shown in FIG. 20.

The measurement signal output module 231 outputs a test sound to measure, from the earphone 200 by outputting a measurement signal to the sound controller 106 (block 501). Sound output from the earphone 200 is received by the microphone 113 (block 502). The obtained received signal is supplied to the impulse-response calculator 233. The impulse-response calculator 233 calculates an impulse response by convolving inverted TSP signal data 241 onto the measurement signal (block 503). The impulse-response calculator 233 supplies the calculated impulse response to a frequency-characteristic calculator 234. The frequency-characteristic calculator 234 calculates a frequency amplitude spectrum by performing Fourier conversion on the impulse response (block 504).

The target-characteristic obtaining module 402 obtains target characteristic data from the target characteristic storage 403 (block 505). The correction-filter design module 404 designs the correction filter 405, based on the frequency characteristic data 235 and the target characteristic data (block 506).

The decoder 406 decodes compressed and encoded music data (block 507). The corrector 407 corrects the decoded music data, based on the correction filter 405 (block 508). The corrector 407 outputs corrected music data to the sound controller 106. The sound controller 106 converts music data into a music signal, amplifies the converted music signal, and outputs the amplified music signal to the earphone 200 (block 509).

The procedure may alternatively be configured to perform blocks 501 to 506 and to then store a parameter of the designed correction filter. When reproducing music, the parameter may be read, and processing may then be started from block 506. Characteristics of the earphone do not greatly vary. Therefore, if only blocks in the first half of the procedure are carried out in advance to obtain a parameter for the correction filter, labor of measurement can be thereafter saved by using the parameter.

According to the present embodiment, sound close to ideal sound for the earphone 200 is heard when the sound is heard through the earphone 200. Therefore, high-quality music can be enjoyed when music is reproduced. Even with the earphone 200 of a low price which does not have an excellent characteristic, the characteristic of the earphone 200 can be easily corrected.

The coefficient for the correction filter is designed by comparing a measured frequency characteristic with an ideal characteristic of the earphone. This means that a filter which compensates for difference between characteristics of two earphones is designed. Accordingly, even when an equal change is applied to the two characteristics, the change is not reflected on the difference therebetween.

### Modification

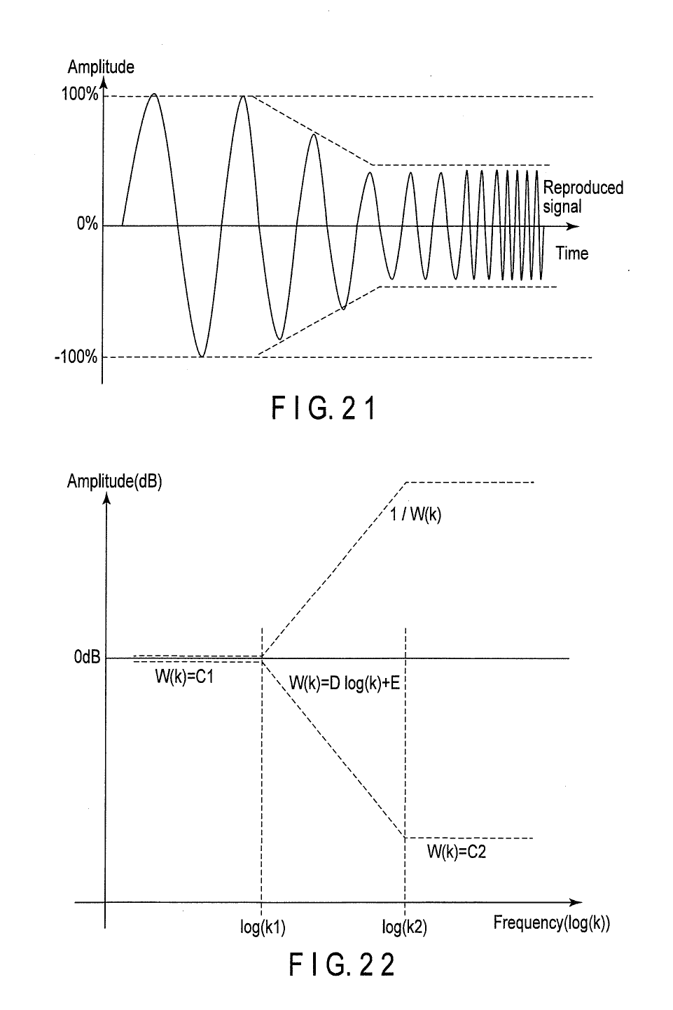

FIG. 21 shows amplitude control of the TSP signal shown in FIG. 10 which is flattened within a predetermined range in low- and high-frequency bands. When the level in the low-frequency band is increased too much, there is a problem that deformation of a reproduced signal increases. Flattening to a certain level is therefore effective. If the signal is reduced to be too small in the side of the high-frequency band, quantization deformation increases and causes a problem of a drop in accuracy of a reproduced signal. Therefore, providing a lower limit to the amplitude of the measured signal is effective. Even a method of processing only one side is effective.

FIG. 22 is a graph showing a weight coefficient W(k) used when creating a TSP signal shown in FIG. 21, and 1/W(k) used when creating an inverted TSP signal thereof. Compared with the case of FIG. 11, the amplitude in the low- and high-frequency bands is limited thereby to cause neither a too great signal nor a too small signal.

The weight W(k) indicates a first value C1 in a low-frequency band (˜log(k1)) lower than a first frequency, and indicates a value from the first value C1 up to a second value C2 lower than the first value C1 in a frequency band (between log(k1)˜log(k2)) between the first frequency and a second frequency higher than the first frequency. The weight W(k) indicates the second value C2 in a frequency band higher than the second frequency (log(K2)˜).

The weight 1/W(k) applied to the inverted TSP is designed to be symmetrical to the weight W(k) in relation to 0 dB.

The above steps of calculation of an impulse response, calculation of a frequency characteristic, and processing of a reproduction function can be configured as a program. The software program can be installed in and executed from an ordinary computer by a computer-readable recording medium storing the program. Then, the same effects as obtained in the foregoing embodiment can be easily achieved.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A measurement apparatus configured to measure an impulse response by using an object system comprising an output device configured to output a first output signal corresponding to a supplied first measurement signal for sweeping a frequency, and a receiving device configured to output a first received signal by receiving the first output signal, the first received signal having a known characteristic of an amplitude spectrum, the apparatus comprising:
an output module configured to output, to the output device, a second measurement signal obtained by multiplying the first measurement signal by a weight comprising an inverted characteristic of the amplitude spectrum;
a receiving module configured to receive a second received signal output from the receiving device when the second measurement signal is supplied from the output module to the output device; and
an impulse response calculator configured to calculate the impulse response by convolving the second received signal and an inverted measurement signal having an inverted characteristic of the second measurement signal.

2. The apparatus of claim 1, wherein the first measurement signal comprises a sine sweep signal whose frequency sequentially varies with time.

3. The apparatus of claim 2, wherein the sine sweep signal comprises a time-stretched pulse (TSP) signal.

4. The apparatus of claim 1, wherein an amplitude of the first measurement signal decreases as the frequency decreases, and
the weight decreases as the frequency increases.

5. The apparatus of claim 4, wherein the output device comprises a closed-type earphone, and
the receiving device comprises a microphone and configured to receive an output signal output from the output device.

6. The apparatus of claim 4, wherein the weight takes a first value for a low-frequency band lower than a first frequency, takes a value between the first value and a second value lower than the first value for a frequency band between the first frequency and a second frequency higher than the first frequency, and takes the second value for a frequency band higher than the second frequency.

7. The apparatus of claim 1, further comprising a frequency characteristic calculator configured to calculate a frequency characteristic of a second output signal output from the output device, when the second measurement signal is supplied from the output module to the output device.

8. The apparatus of claim 1, wherein the impulse response calculator is configured to calculate a product of the second received signal and Fourier conversion of the inverted measurement signal.

9. The apparatus of claim 1, further comprising a storage configured to store measurement signal data indicative of the second measurement signal.

10. A measurement method for measuring an impulse response by use of an object system comprising an output device configured to output an output signal corresponding to a supplied first measurement signal for sweeping a frequency, and a receiving device configured to output a first received signal by receiving the first output signal, the first received signal having a known characteristic of an amplitude spectrum, the method comprising:
supplying, to the output device, a second measurement signal to sweep the frequency;
receiving a second received signal output from the output device when the second measurement signal is supplied to the output device; and
calculating the impulse response by convolving the second received signal and an inverted measurement signal having an inverted characteristic of the second measurement signal, wherein
the second measurement signal has a signal characteristic obtained by multiplying the first measurement signal by a characteristic of a characteristic of the amplitude spectrum.

11. A playback apparatus configured to measure an impulse response by use of an object system comprising an earphone configured to output an output signal corresponding to a supplied first measurement signal for sweeping a frequency, and a microphone configured to output a first received signal by moving close to the earphone and receiving the output signal, the first received signal having a known characteristic of an amplitude spectrum, the apparatus comprising:
an output module configured to output, to the earphone, a second measurement signal obtained by multiplying the first measurement signal by a weight having an inverted characteristic of the characteristic of the amplitude spectrum;
a receiving module configured to receive a second received signal output from the microphone when the second measurement signal is supplied from the output module to the earphone;
an impulse response calculator configured to calculate the impulse response by convolving the second received signal and an inverted measurement signal having an inverted characteristic of the second measurement signal;
a frequency calculator configured to calculate frequency characteristic data indicating a frequency characteristic of the second received signal, based on the impulse response;
a correction data generation module configured to generate correction data for correcting the frequency characteristic, based on the frequency characteristic data and target frequency characteristic data indicating a target frequency characteristic;
a correction module configured to correct audio data, based on the correction data; and
an audio signal output module configured to output, to the earphone, an audio signal based on the corrected audio data.
